(19) United States
(12) Patent Application Publication
(10) Pub. No.: US 2008/0255849 A9
(43) Pub. Date: Oct. 16, 2008

(54) Voice activated mammography information systems

(76) Inventor: Gregory A. Gustafson, Independence, MN (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 11/603,554

(22) Filed: Nov. 22, 2006

Related U.S. Application Data
(60) Provisional application No. 60/738,824, filed on Nov. 22, 2005.

(51) Int. Cl. G10L 21/00

(52) U.S. Cl. 704/275

(57) ABSTRACT

A mammography information system (“MIS”) including voice command and audio feedback capabilities. A radiologist using the MIS can navigate a MIS application using voice command, thus enabling a “heads-up” and “hands free” environment for the radiologist and minimizing the amount of time required for reading mammograms. The MIS can include an audio playback feature enabling a radiologist to confirm each of the settings or variables included on the various screens while looking at an image without looking at the monitor.

### RELATED APPLICATION

This application claims the benefit of U.S. Provisional Application No. 60/738,824, filed Nov. 22, 2005, which is incorporated herein by reference in its entirety.

### COMPACT DISC

A compact disc containing codes and information describing a preferred embodiment of the present invention is submitted herewith and is hereby incorporated by reference. The compact disc contains the following files and/or programs:

| Title | Size in Bytes | Date of Creation |
|---|---|---|
| AlternativePhrase.cs.txt | 1,615 | Nov. 17, 2005 |
| Annunciator.cs.txt | 7,344 | Nov. 17, 2005 |
| AssemblyInfo.cs.txt | 2,041 | Nov. 17, 2005 |
| BaseDialog.cpp.txt | 28,065 | Nov. 17, 2005 |
| BaseDialog.h.txt | 5,940 | Nov. 17, 2005 |
| DataAccessLayer.cs.txt | 10,044 | Nov. 17, 2005 |
| DataAdapterFactory.cs.txt | 7,338 | Nov. 17, 2005 |
| GrammarArrayList.cs.txt | 2,209 | Nov. 17, 2005 |
| GrammarFactory.cs.txt | 10,788 | Nov. 17, 2005 |
| IAnnunciate.cs.txt | 904 | Nov. 17, 2005 |
| ISpokenCommandRecognizer.cs.txt | 2,090 | Nov. 17, 2005 |
| PENRADOC.CPP.txt | 72,195 | Nov. 17, 2005 |
| PENRADOC.H.txt | 23,335 | Nov. 17, 2005 |
| PenResBase.cs.txt | 33,962 | Nov. 17, 2005 |
| PenResBase.xsd.txt | 2,994 | Nov. 17, 2005 |
| PenResBase.xsx.txt | 549 | Nov. 17, 2005 |
| PenResDs.cs.txt | 11,369 | Nov. 17, 2005 |
| RuleInfo.cs.txt | 1,002 | Nov. 17, 2005 |
| SapiExecption.cs.txt | 21,832 | Nov. 17, 2005 |
| SpeechRecognizer.cs.txt | 37,474 | Nov. 17, 2005 |
| SpeechRecognizerEvents.cs.txt | 2,287 | Nov. 17, 2005 |
| SpokenCmdMgr.cpp.txt | 11,140 | Nov. 17, 2005 |
| SpokenCmdMgr.h.txt | 3,806 | Nov. 17, 2005 |
| SpokenCmdRecognizer.cpp.txt | 13,024 | Nov. 17, 2005 |
| SpokenCmdRecognizer.h.txt | 2,078 | Nov. 17, 2005 |
| SrMessageSource.cs.txt | 3,494 | Nov. 17, 2005 |
| TextToVoiceMgr.cpp.txt | 11,230 | Nov. 17, 2005 |
| TextToVoiceMgr.h.txt | 2,119 | Nov. 17, 2005 |
| VoiceCommand.cs.txt | 5,482 | Nov. 17, 2005 |

### FIELD OF THE INVENTION

This invention relates generally to mammography information systems. More particularly, this invention relates to a voice activated mammography information system having audio playback features.

### BACKGROUND OF THE INVENTION

In conventional mammography information systems (“MIS”), a radiologist generally begins his or her review process by reviewing a patient's background information relevant to a radiology study, such as a patient's name, age, and any applicable medical conditions or risk factors. After reviewing the background information, the radiologist can visually interpret the patient's mammographic images and create a report with her findings.

While creating the report, the radiologist generally must look back and forth between the images and a monitor while entering data using some type of input device, such as a keyboard, mouse, or touch screen. Such data can include breast information pertaining to tissue density, any cysts or calcifications, or any other breast compositions. The radiologist will often need to glance back and forth between the between the images, monitor, and/or paperwork several times during the course of image interpretation. This can slow the overall process, leading to significant process inefficiencies.

After reviewing the images and generating a report, radiologists can generate a patient letter recommending a later screening mammogram and approve the exam report. Each step of this multi-step process can require significant time.

These inherent deficiencies have not been addressed by conventional systems. As such, there is a current need for an improved MIS application.

### SUMMARY OF THE INVENTION

The MIS of the invention substantially solves the deficiencies inherent with conventional MISs by including voice command and audio feedback capabilities.

A feature and advantage of the invention is that the MIS application is navigable using voice commands. This enables a “heads-up” and “hands free” environment for a radiologist utilizing the MIS application, minimizing the amount of time required for reading mammograms. The system can also include an audio playback feature enabling a radiologist to confirm each of the settings or variables included on the various screens while looking at an image without looking at the monitor.

Another feature and advantage of the invention is that whenever a voice command is given, the system can “echo” back the command by audio to provide verification that the command has been completed, further eliminating the need to look at the screen.

A further feature and advantage of the invention is that configuration options can also be maintained for each individual facility and for each user within the facility, thus enabling flexibility in which features are turned on or off.

Another feature and advantage of the invention is that user defined macros can be used to pre-populate multiple fields and list boxes containing data points that are voice command driven. For example, on a negative mammogram, the radiologist can build a macro that would always select the desired tissue density, generate a normal patient letter, recommend a one-year screening mammogram, and approve the exam.

A further feature and advantage of the invention is that each voice command can include multiple aliases, thus minimizing or eliminating the time needed for each radiologist to learn a very system specific language and inhibiting system errors due to the radiologist using a word or phrase different from that included in the logic of the system.

### BRIEF DESCRIPTION OF THE DRAWINGS

FIG. 1A is a schematic view of an MIS according to one embodiment of the invention.

FIG. 1B is a schematic view of an MIS according to another embodiment of the invention.

FIG. 2 is a first flowchart for a voice command MIS application, depicting the workflow from opening the MIS application to opening a pre-examination (“Pre-Exam”) graphical user interface (“GUI”) according to one embodiment of the invention.

FIG. 3A is a first portion of a second flowchart, depicting audio playback features for various elements included on the “Pre-Exam” GUI according to one embodiment of the invention.

FIG. 3B is a second portion of the flowchart of FIG. 2.

FIG. 4 is a third flowchart, depicting a button voice command workflow for the MIS application according to one embodiment of the invention.

FIG. 5 is a fourth flowchart depicting the flowchart for a “Negative Mammogram” or “Approve Normal Mammogram Exam” GUI according to one embodiment of the invention.

FIG. 6 is a patient list GUI according to one embodiment of the invention.

FIG. 7 is a “Pre-Exam” GUI according to one embodiment of the invention.

FIG. 8 is a “Negative Mammogram” or “Approve Normal Mammogram Exam” GUI according to one embodiment of the invention.

### DETAILED DESCRIPTION OF THE DRAWINGS

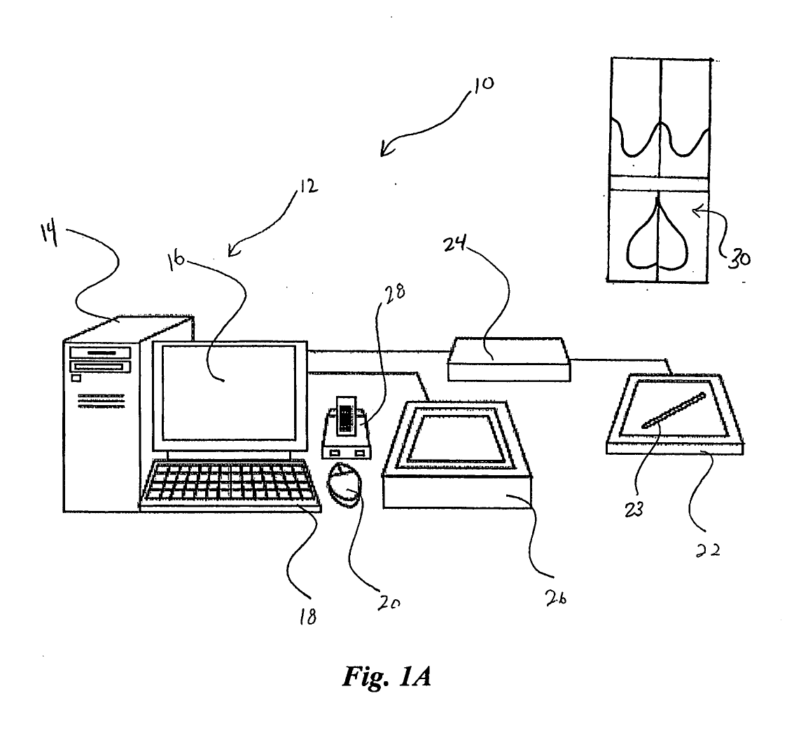

Referring to FIG. 1A, a mammography information system (MIS) 10 according to various embodiments of the invention broadly includes a workstation 12, such as a personal computer, a laptop computer, a networked computer, or the like, having a central processing unit (“CPU”) 14, a monitor 16, and one or more input devices such as a keyboard 18, a mouse 20, and a touch screen/tablet 22 optionally including a stylus 23. In another embodiment, a local CPU 14 is omitted or not utilized, and workstation 12 operates via a network such as a local area network (LAN), wide area network (WAN), the Internet, or some other compatible data network. Workstation 12 further includes an MIS application of the invention loaded thereon. Workstation 12 can also include microphone and speakers known to those skilled in the art for use in the voice command and audio feedback features.

MIS 10 can also include a network hub 24 for connecting workstations 12 together for data and printer sharing and a printer 26 for printing exams and various patient correspondence. MIS 10 can also include a bar-code system 28, comprising one or more of a label printer, wand, gun, and the like, for bar-code awareness to automate exam and patient identification. When using MIS 10 of the invention, a radiologist or other user will often be looking at mammographic x-ray images 30, either film based images on a viewbox/alternator or digitally based images on a computer system. Those skilled in the art will recognize that other components can be included in MIS 10 without departing from the scope and spirit of the invention. For example, FIG. 1B depicts another embodiment of an MIS 10 according to the invention, comprising a master workstation 12B, additional network workstations 12C, such as in imaging rooms, and a mobile workstation 12D. FIGS. 1A and 1B are only example embodiments, and more or fewer workstations 12 can be included in other embodiments of the invention.

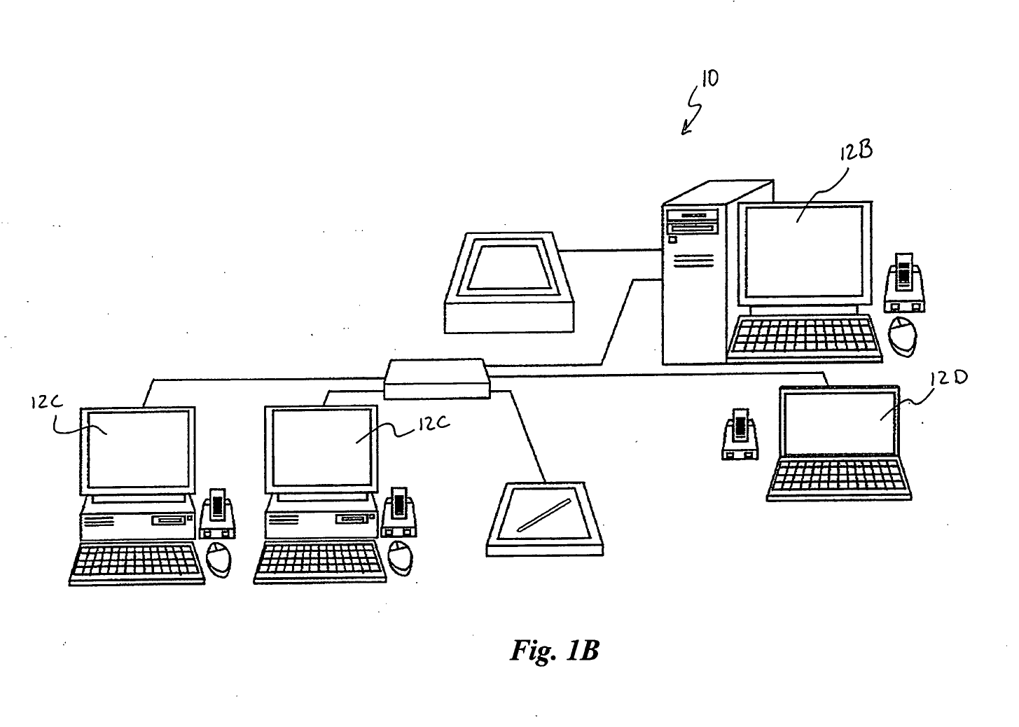

Referring to FIG. 2, the MIS application is opened on workstation 12 at step 32, and MIS 10 will determine if a speech recognition function has been configured to run on the MIS application at step 34. If speech recognition function has been configured to run on the MIS application (i.e., the speech recognition function is enabled), the speech recognition files are loaded on workstation 12 at step 36, and a user can log into the MIS application at step 38. If the speech recognition function has not been configured to run on the MIS application, the MIS application can run without the speech recognition function enabled at step 40.

The MIS application will then determine if a voice profile is indicated by MIS 10 for the user logging into MIS 10 at step 42. Specifically, each user of a particular MIS application on a workstation 12 can create a unique voice profile that is specifically adjusted and trained to their voice and speech patterns through an available speech wizard. The voice training can improve the accuracy of the voice recognition system by properly configuring the voice profile for a respective user. Each user's voice profile can be indicated within MIS 10 such that when a user logs into MIS 10, MIS 10 will automatically load that user's voice profile at step 44.

If there is a voice profile indicated by MIS 10 for the user logging into MIS 10, the user's voice profile can be loaded at step 44. If there is no voice profile indicated for any given user, MIS 10 can default to a default voice profile at step 46. Those skilled in the art will recognize that a new user can create his or her voice profile during the use of the MIS application.

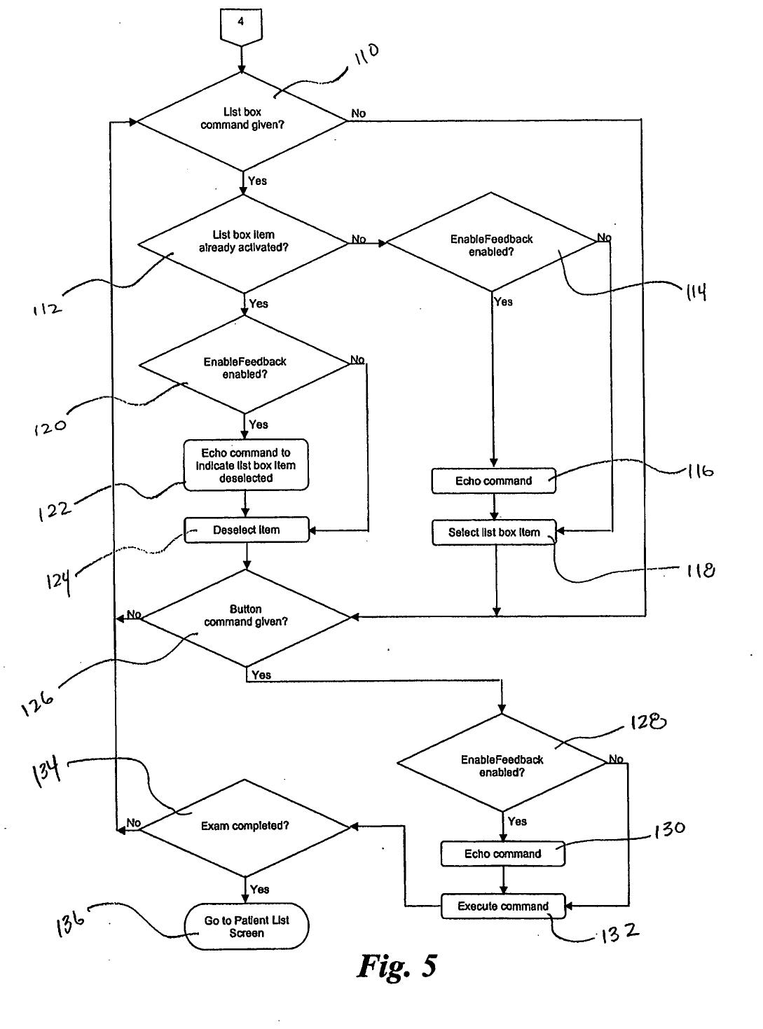

Once the user's voice profile is loaded (or a default voice profile is loaded), an electronic patient record for a patient can be selected at step 48 off of a patient list GUI, which is depicted in FIG. 6. This selection generally can be done using a barcode gun 28 and/or by selecting the patient's record off a list of patients using an input device 20 such as a keyboard, mouse, or touch screen. If speech recognition is enabled, the patient's record can also be selected by using a voice command.

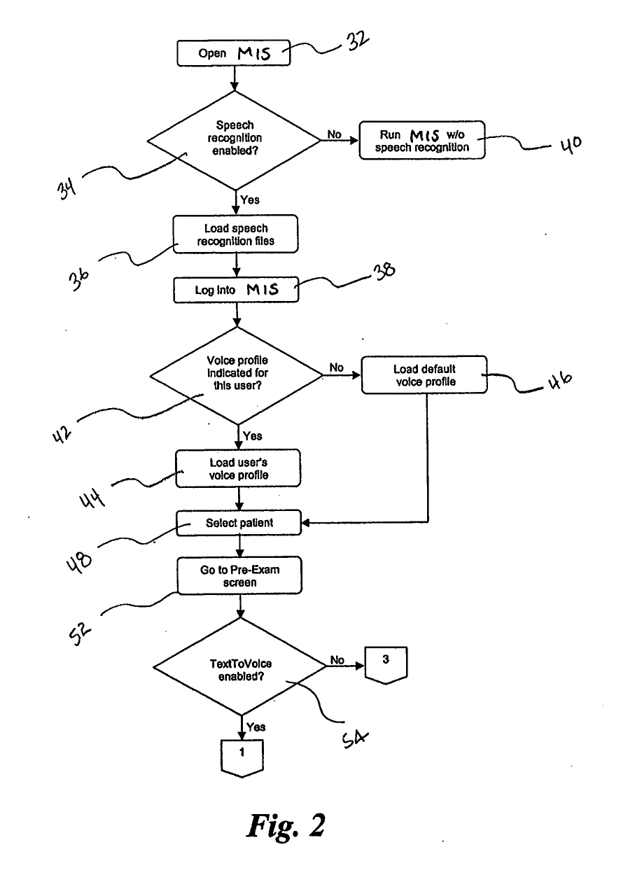

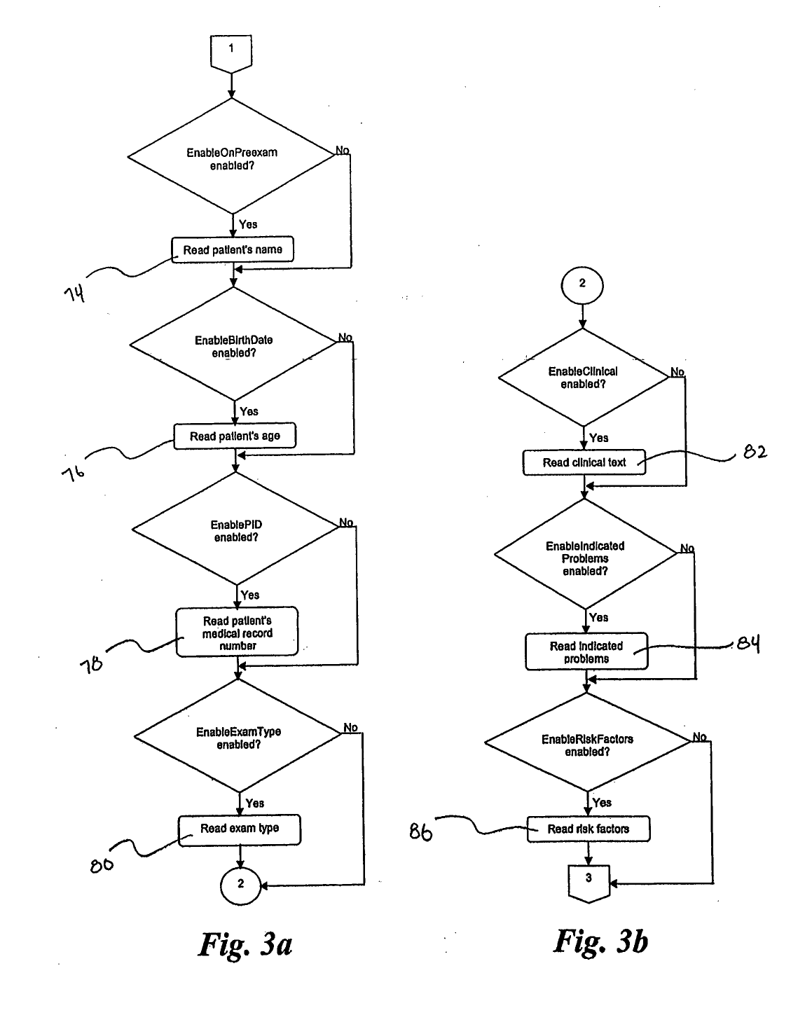

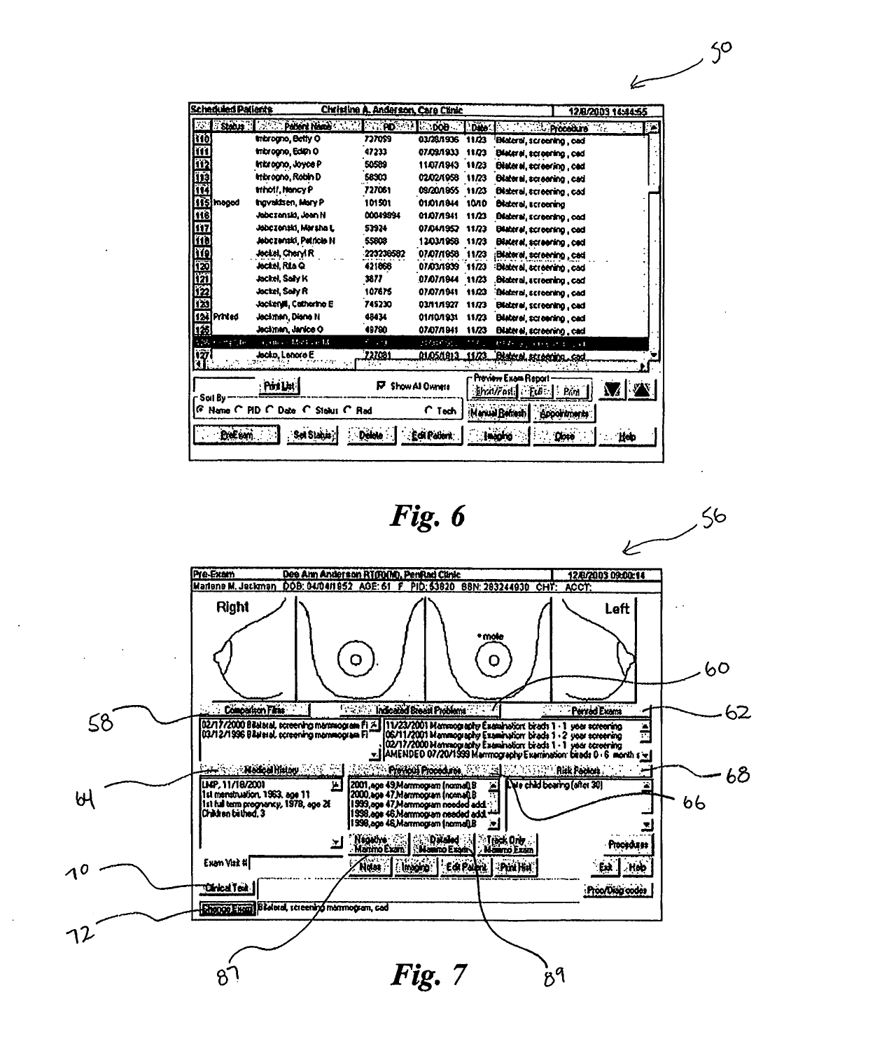

Referring also to FIG. 7, once a patient's record has been selected, a “Pre-Exam” GUI 56 can be loaded by MIS 10 at step 52. MIS 10 will determine if audio playback is configured to run on the MIS application at step 54. If the audio playback on “Pre-Exam” GUI 56 is enabled, MIS 10 can provide an audio summary of “Pre-Exam” GUI 56 to the radiologist as depicted in FIGS. 3A and 3B and as described in greater detail below. If the audio playback on “Pre-Exam” GUI 56 is not enabled, MIS 10 can go directly to the button command flowchart as depicted in FIG. 4, thus bypassing the audio playback flow charts as depicted in FIGS. 3A and 3B.

Referring to FIG. 7, “Pre-Exam” GUI 56 loaded after a patient has been selected can display pertinent information related to the exam, including but not limited to comparison film information 58, any indicated breast problems 60, other examinations 62, a patient's medical history 64, previous procedures 66, and any risk factors 68. “Pre-Exam” GUI 56 can also include any clinical text 70 and a “Change Exam” button 72 to change the exam information. Other voice commands and features of “Pre-Exam” GUI 56 can be seen in greater detail in FIG. 7. Those skilled in the art will recognize that additional buttons and fields can be included in “Pre-Exam” GUI 56 without departing from the scope and spirit of the present invention.

Referring to FIGS. 3A and 3B, if the audio playback on “Pre-Exam” GUI 56 is enabled, MIS 10 can provide an audio summary of the various fields of “Pre-Exam” GUI 56 to the radiologist. While receiving the Pre-Exam audio summary, the radiologist can simultaneously make a visual interpretation of the mammography images and listen to the audio summary. The audio playback feature is user or system configurable to be on or off and user or system configurable to be stopped or started at any time during a report generation.

Some of the commands or fields that can be “read” by voice to the radiologist while “Pre-Exam” GUI 56 is open include a patient's name 74 and age 76, a patient's medical record number 78 (i.e., patient identification or “PID” number), an examination type 80, any clinical text 82, any indicated problems 84, and any patient risk factors 86. Before each of the fields is read by MIS 10, MIS 10 will determine if the audio playback for each or all of the fields is enabled.

The audio playback/summary feature can eliminate or minimize a radiologist's need to visually scan the screen while interpreting images. The radiologist can elect to listen to the entire summary or give a voice command to stop the summary at any time. Voice activation of any of the buttons or fields on the screen also enables the radiologist to access various screens to make any desired changes. In the various embodiments of the invention, each button included on the various GUIs can be voice activated.

Referring to FIG. 7, and to generate a narrative report, the radiologist can issue a voice command to activate any of the command buttons on “Pre-Exam” GUI 56, including “Negative Mammo Exam” and “Detailed Mammo Exam” buttons 87 and 89, respectively. Generally, “Negative Mammo Exam” button 87 would be selected when the results of the test are negative. Conversely, “Detailed Mammo Exam” button 89 would be selected when the results of the test are not negative. These voice commands will direct the application to the next appropriate screen (either “Approve Normal Mammogram Exam” GUI 98 or “Detailed Mammo Exam” GUI (not depicted)).

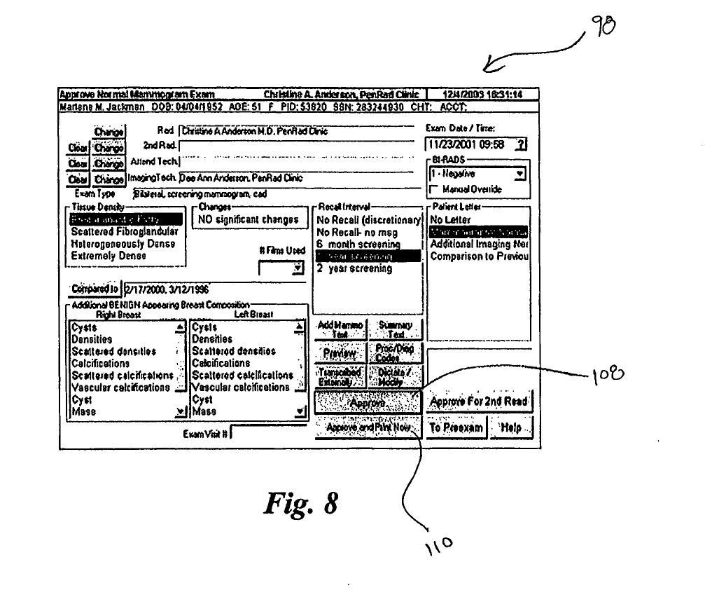

Referring to FIG. 4, when a radiologist issues a voice command at step 88, MIS 10 will determine if it is a “Negative Mammogram” voice command at step 90. If MIS 10 determines that a voice command is a “Negative Mammogram” command, the application can determine if audio playback is activated at step 92, and if so, “echo” back the command at step 94 by audio to provide verification that the command has been completed, thus minimizing or eliminating the need for a user to look at the screen. For example, when the radiologist issues a “Negative Mammogram” voice command, MIS 10 can echo the “Negative Mammogram” command back by audio to the radiologist at step 94. MIS 10 can then activate the Negative Mammo Exam button at step 96 to display the “Approve Normal Mammogram Exam” GUI at step 98, which is depicted in FIG. 8.

If the voice command given by the user is not the “Negative Mammogram” voice command, but rather another voice command on “Pre-Exam” GUI 56, the application can determine if audio playback is activated at step 100, and if so, “echo” back the command at step 102 by audio to provide verification that the command has been completed and execute the command at step 104.

Referring again to FIG. 4 and also to FIG. 8, if the user selected the “Negative Mammogram” voice command and the “Approve Normal Mammogram Exam” GUI 98 is opened at step 96, the application can determine if audio playback on the “Approve Normal Mammogram Exam” GUI 98 is enabled at step 106. If so, MIS 10 can provide an audio summary of the highlighted areas at step 108 from the “Approve Normal Mammogram Exam” GUI 98.

Referring to FIG. 8, if the radiologist agrees with the summary as initially displayed, she can then orally issue the “Approve” command/button 108 or “Approve and Print Now” command/button 110 to complete the exam. These voice commands automatically generate (and optionally print) the report. This can often be the case in situations where a mammogram comes back “negative,” as the information might not have changed since a last visit or test by the patient. Because MIS 10 will retain the previous information of the patient, the information included on the “Approve Normal Mammogram Exam” GUI 98 might be correct once it is initially opened.

However, for each of the buttons and fields included on the “Approve Normal Mammogram Exam” GUI 98, a user can orally instruct MIS 10 and MIS 10 can echo the voice command back to the user by audio and then select the list box item. In other words, whenever a voice command is given in the “Approve Normal Mammogram Exam” screen, MIS 10 can “echo” back the voice command by audio to provide verification that the command has been completed, eliminating the need to look at the screen. For example, if the “right cyst” voice command is spoken in the “Approve Normal Mammogram Exam” screen, MIS 10 will echo back “right cyst” by audio and the right cyst data point will be highlighted in the appropriate list box. If the “right cyst” voice command is given again, MIS 10 will echo back “deselected right cyst” by audio to indicate that the right cyst data point has been cleared.

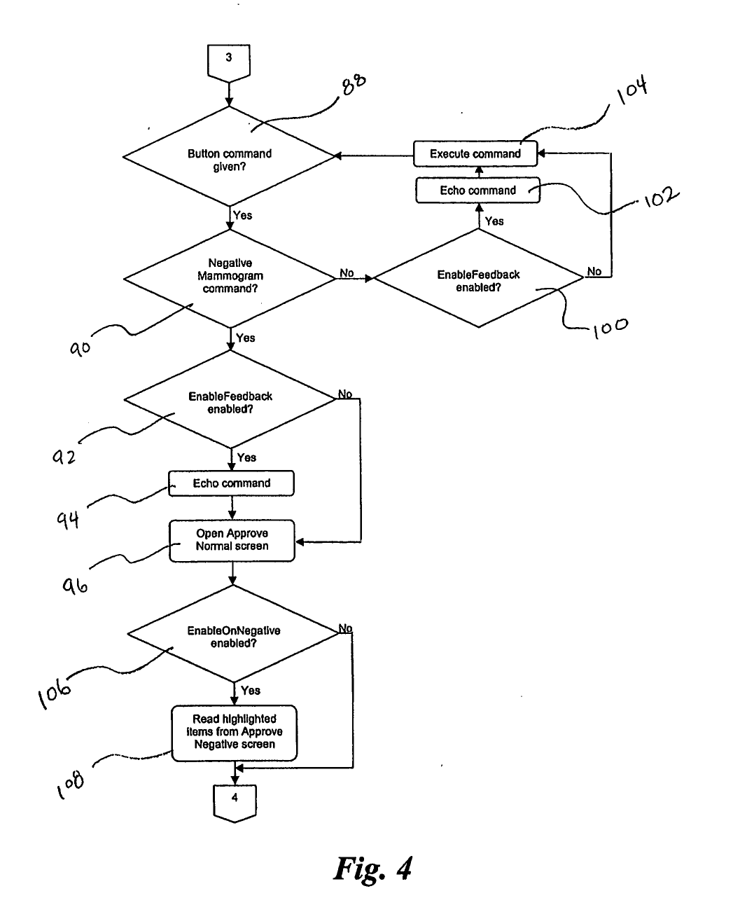

Referring to FIG. 5, if the radiologist wishes to make any changes to the report, he or she has the option to orally change any of the list box items by simply speaking that list box command by item at step 110 or by manually selecting the item using a mouse, keypad, or touch screen. MIS 10 will determine if the list box item is already selected at step 112. If not, MIS 10 will determine if the audio feedback is enabled for the field at step 114, and if so, MIS 10 can echo the command back to the user by audio at step 116 and select the list box item at step 118. If the user would like to deselect a list box item, the user can give the list box command on an item that is already activated. The application can determine if audio playback is activated at step 120, and if so, “echo” back the list box item to be deselected to the user by audio at step 122 and then deselect the item at step 124.

The radiologist can also give a voice command at step 126 on the “Approve Negative” GUI 98. MIS 10 will determine if the audio feedback is enabled for the command at step 128, and if so, MIS 10 can echo the command back to the user by audio at step 130 and then execute the command at step 132.

These steps can be repeated until the radiologist agrees with the summary, at which time he or she can orally issue the “Approve” voice command that activates the “Approve” or “Approve and Print Now” buttons to complete the exam. MIS 10 will determine if the exam is completed at step 134. If not, the above processes can be repeated. If so, MIS 10 will return to the patient list at step 136. At any point during the report generation, the radiologist can replay the audio summary with the changes made by issuing the “playback” voice command. The audio summary can also be stopped at any time by issuing the “stop” voice command.

Those skilled in the art will recognize that a substantially similar process can also be included for a detailed or abnormal mammogram. Moreover, those skilled in the art will recognize that additional screens and options are available for the detailed or abnormal mammogram.

In the various embodiments, multiple list box items (i.e., data points) can be selected or deselected with a single voice command. For example, separate list boxes are included for benign findings for the right and left breasts. With non-oral user input of conventional systems, if one wanted to select bilateral calcifications, separate selections would have to be made for both the right and left sides. With oral input, one would simply say, “bilateral calcs” in the “Approve Normal Mammogram Exam” screen to select calcifications in both list boxes.

In various embodiments of the invention, multiple user-defined macros can also be included to pre-populate multiple fields and list boxes containing data points that are voice command driven. For example, on a negative mammogram, the radiologist can build a macro that would always select the desired tissue density, generate a normal patient letter, recommend a one year screening mammogram and approve the exam. In conventional systems, these are all separate fields or list box selections that require four separate actions. To activate the macro, the radiologist would simply have to speak the macro name, which would automatically complete the four selections.

Macros can be generated for various situations and maintained for individual radiologists but can also be specified as global macros to be used by all radiologists at their facility. Configuration options can also be maintained for each individual facility and for each user within the facility, thus enabling flexibility in which features are turned on or off.

Another aspect of various embodiments of the invention is that each of the voice commands, fields, and list box items can be given multiple aliases, thus minimizing or eliminating the time needed for each radiologist to learn a very system specific language and inhibiting system errors due to the radiologist using a word or phrase different than that included in the logic of the system. As an example, in “Pre-Exam” GUI 56 depicted in FIG. 6, one button voice command is the “Negative Mammo Exam” button. If a user desires to select the “Negative Mammo Exam” button and move into the “Approve Normal Mammogram Exam,” the user can orally recite a number of different aliases for the “Negative Mammo Exam” button, such as “negative mammo exam,” “negative,” negative mammo,” and other phrases that are assigned to the button in MIS 10. Generally, these aliases are assigned into the software by the software maker. However, those skilled in the art will recognize that such aliases could be later trained into MIS 10 by facility or by individual user.

In addition, the vocabulary required by a voice engine can be limited to the list box items and buttons included on the program, which can improve the overall speed and accuracy of the voice recognition process. Specifically, MIS 10 is not required to recognize tens of thousands of words. Rather, the vocabulary list can be pre-determined by what is included on the screen (e.g., list box items and buttons), such that overall vocabulary list can be much shorter. As a result, the speed and accuracy of the voice recognition process can be significantly improved.

Moreover, when the MIS application is opened, MIS 10 can load a separate grammar file and/or vocabulary list for each screen. As a result, the MIS application reads only the grammar file and/or vocabulary list associated with that screen, thus further improving speed and accuracy of the voice recognition. The grammar file and/or vocabulary list can be further reduced based upon the actual list box that is being accessed.

Thus, various embodiments of the invention offer innovative real-time and real-world features to complement, enhance, and automate mammography information systems. The GUI of embodiments of the MIS of the invention is graphical and can incorporate drag and drop technology to automate data entry with use of a mouse or touch screen. Drop-down menu selection items can be limited to facilitate full display and full description of selections for one-glance viewing for additional efficiencies.

In one embodiment, the software platform is based on a client-server architecture where a database and associated program files reside on a server or master workstation. A client workstation can have a shortcut icon to the software program and an ODBC connection to the server engine that services requests from the client workstation. For example, in one embodiment the software platform is MICROSOFT (MS), and an MS SQL server is the database engine. Replication can be supported for mobile van systems and roll-up servers. The program of the invention can use OLE automation to communicate with MS WORD, for example, or another word processing program, for the generation of correspondence with virtually unlimited formatting capabilities. Administrative report generation can also be facilitated by SQL queries to the database and can allow formatting. In one embodiment, the system of the invention can comprise an autofax system, such as an NP/2000 service, that can reside on the server and utilize a support modem or other communication line to provide faxing of reports from a workstation. The system of the invention can also offer bi-directional interfaces to HIS/RIS systems using, for example, NT/2000 service software that reside on the server and communicates via TCP/IP to the HIS/RIS. In one embodiment, the interface software can be easily configured, set-up, and changed to match differences, requirements, protocols, and formatting between HIS/RIS vendors.

In one embodiment, the program is networked to one or more client workstations using, for example, any WINDOWS supported network protocol software. WINDOWS terminal server technology (thin client) can also be supported for client workstations. Connections can be 10baseT network topography, intranet, ISDN, DSL, T1, or other compatible connections. In various embodiments, the program can operate on MICROSOFT WINDOWS 95, 98, NT, or 2000 operating systems, although other operating systems and platforms can also be compatible. The software programs can be developed utilizing MICROSOFT C++, MICROSOFT FOUNTAIN CLASSES, OLE and ODBC for SQL communication, to operate in as a stand-alone or client server in various embodiments of the invention. The program can be multi-treaded, permitting multi-tasking such as reading film ID, printing, report generation, etc. In one embodiment, the system is automatically scalable for stand-alone, enterprise, or integrated solutions as facility needs expand or change.

Although the present invention has been described with reference to particular embodiments, one skilled in the art will recognize that changes can be made in form and detail without departing from the spirit and the scope of the invention. For example, the voice command and feedback system can be used in various medical systems and with various radiology modalities, including but not limited to various imaging systems (e.g., computed tomography (CT) imaging system, ultrasound systems, x-ray imaging systems, and magnetic resonance imaging (MRI) systems). Therefore, the illustrated embodiments should be considered in all respects as illustrative and not restrictive.

What is claimed is:

1. A mammography information system (MIS) comprising:
at least one mammogram image handling workstation communicatively coupled to a network, the at least one mammogram image handling workstation comprising a graphical user interface (GUI) adapted to display a mammogram image file and an audio user interface; and
an MIS image handling application operating on the at least one mammogram image handling workstation, wherein the MIS image handling application comprises a speech recognition function, and wherein the speech recognition function is adapted to facilitate control of the at least one mammogram image handling workstation to selectively provide simultaneous visual information and audible information from a mammogram image file via the GUI and the audio user interface, respectively.

2. The MIS of claim 1, wherein the audio user interface comprises an audio input device and an audio output device.

3. The MIS of claim 2, wherein the speech recognition function comprises at least one voice profile.

4. The MIS of claim 3, wherein the speech recognition function comprises a default voice profile and at least one custom user voice profile, wherein the at least one custom user voice profile is user-created via the audio input device.

5. The MIS of claim 4, wherein the at least one custom user voice profile comprises at least one user-defined alias.

6. The MIS of claim 1, wherein the visual information comprises at least one of a mammogram image, a patient identifier, a patient medical history, a patient procedural history, and a patient risk factor.

7. The MIS of claim 1, wherein the audible information comprises at least one of a patient identifier, a patient medical history, a patient procedural history, and a patient risk factor.

8. The MIS of claim 1, wherein the MIS image handling application further comprises a report generation application, and wherein the speech recognition function is further adapted to provide selective control of the report generation application.

9. The MIS of claim 1, wherein the MIS image handling application further comprises a macro generation function.

10. A method of using a mammography information system (“MIS”) comprising the steps of:
activating an MIS comprising a graphical user interface (GUI) and an audio user interface;
selecting a patient file for review in the MIS, wherein the patient file comprises at least one mammogram image, and wherein the patient file is selected by an input to one of the GUI and the audio user interface;
determining if a speech recognition function of the MIS is activated;
if the speech recognition function is activated, simultaneously displaying at least a portion of the patient file in the GUI and providing audible patient file information via the audio user interface; and
if the speech recognition function is not activated, displaying at least a portion of the patient file in the GUI.

11. The method of claim 10, further comprising the step of creating a custom voice profile for the speech recognition function.

12. The method of claim 11, further comprising the step of selecting a voice profile from a set of available voice profiles, wherein the set comprises a default voice profile and at least one custom voice profile.

13. The method of claim 12, further comprising the step of creating at least one custom command alias as a portion of a custom voice profile.

14. The method of claim 10, further comprising the step of navigating the patient file in the MIS, wherein the patient file is navigated by voice command if the speech recognition function is activated and by GUI input if the speech recognition function is not activated.

15. The method of claim 13, wherein the step of navigating further comprises creating a custom macro to automate patient file manipulation.

16. A mammogram image handling application operating in communication with a mammography inform system (MIS), the image handling application comprising:
a graphical user interface (GUI) function adapted to facilitate visual display of a mammogram image file on a plurality of GUI screens, wherein the mammogram image file comprises at least one mammogram image; and
a speech recognition function adapted to facilitate control of the MIS and the GUI, wherein the speech recognition function comprises a plurality of grammar files, each of the plurality of grammar files associated with at least one of the plurality of GUI screens,
wherein the GUI and the speech recognition function selectively provide simultaneous visual information and audible information from the mammogram image file via the MIS.

17. The mammogram image handling application of claim 16, wherein the speech recognition function further comprises a custom voice profile creation function.

18. The mammogram image handling application of claim 17, wherein the custom voice profile creation function comprises a custom macro creation function.

19. The mammogram image handling application of claim 17, wherein the custom voice profile creation function comprises an alias definition creation function.

20. The mammogram image handling application of claim 16, wherein each of the plurality of grammar files comprises a vocabulary list associated with at least one of the plurality of GUI screens.
